(19) United States
(12) Patent Application Publication
(10) Pub. No.: US 2006/0055808 A1
(43) Pub. Date: Mar. 16, 2006

(54) Method for increasing storage space in a digital camera apparatus

(75) Inventors: Sook-young Maeng, Seongnam-si (KR); Myung-chun Kim, Seongnam-si (KR); Kyoung-shin Kim, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/029,914

(22) Filed: Jan. 5, 2005

(30) Foreign Application Priority Data
Sep. 16, 2004 (KR) 2004-74191

(51) Int. Cl. H04N 5/222

(52) U.S. Cl. 348/333.11

(57) ABSTRACT

A method for operating a digital camera is provided. Particularly, the method provides for increasing image storage space by changing the resolution of a stored image when photographing a new image. The method includes: displaying images stored in the storage space on a thumbnail screen when a menu for changing a resolution is selected; selecting from the images displayed on the thumbnail screen an image whose resolution is to be changed; and changing a resolution of the selected image when the selection of the image is completed.

This application claims priority from Korean Patent Application No. 2004-74191 filed on Sep. 16, 2004, in the Korean Intellectual Property Office, the disclosure of which is incorporated herein in its entirety by reference.

### BACKGROUND OF THE INVENTION

1. Field of the Invention

The present invention relates generally to a digital camera apparatus, and more particularly to a method for increasing the available storage space for storing an image in a digital camera apparatus by reducing the resolution of previously stored images.

2. Description of the Related Art

FIG. 1 is a flowchart illustrating a conventional method of changing the resolution of an image stored in a digital camera. First, a menu for changing a resolution is selected (Operation 100), and an image is selected (Operation 102) for changing that image's resolution. After selecting the image, the new resolution for the selected image is chosen (Operation 104). The resolution of the selected image is changed into the new resolution (Operation 106), and when the resolution change of the image is completed (Operation 108) the selected image is then stored as a new image file (Operation 110).

Such a conventional function to change the resolution of an image in the digital camera applies to only one image, and disadvantageously, various images cannot be changed instantly to the same resolution. In addition, in such a conventional function, a resolution of an image cannot be changed if there is not enough storage space to store the new image.

### SUMMARY OF THE INVENTION

The present invention provides a digital camera apparatus and a method for increasing image storage space in a digital camera apparatus by reducing the resolution of stored images.

According to an aspect of the present invention, a method is provided for increasing an image storage space by changing a resolution of an image when a newly photographed image cannot be stored due to a lack of storage space. The method includes the steps of: displaying images stored in the storage space on a thumbnail screen; selecting from the displayed images on the thumbnail screen an image whose resolution is to be changed; and changing the resolution of the selected image.

The changed resolution image may be stored over the original image.

The image selecting step includes various options such as choosing all images, choosing a series or range of images, or selectively picking and choosing a number of images stored in the storage space.

According to another aspect of the present invention, a digital camera apparatus is provided that increases image storage space when a photographed image cannot be stored. The apparatus includes: a display unit that displays images stored in the storage space on a thumbnail screen, and displays selected images among the images displayed on the thumbnail screen differently from the stored images; an operating unit that selects an image among the images displayed on the thumbnail screen, and selects a menu for selecting a resolution of the selected image; and a controlling unit that provides and controls a predetermined menu, which is used to operate the display unit and the operating unit, provides a menu through which a resolution of an image can be changed when an image whose resolution is to be changed by the operating unit is selected from the thumbnail screen displayed on the display unit, and changes the resolution of the selected image according to the selected resolution.

The operating unit can select all images or a select number of images stored in the storage space.

### BRIEF DESCRIPTION OF THE DRAWINGS

The foregoing described features of the present invention will become more apparent by describing in detail exemplary embodiments thereof with reference to the attached drawings, in which:

FIG. 1 is a flowchart illustrating a conventional method of changing the resolution of an image stored in a digital camera;

FIG. 2 is a front perspective view of a digital camera;

FIG. 3 is a rear view of the digital camera of FIG. 2;

FIG. 4 is a view illustrating a structure of a light incident surface of the digital camera of FIG. 2;

FIG. 5 is a block diagram in accordance with the digital camera of FIG. 2;

FIG. 6 is a block diagram illustrating an apparatus for increasing a storage space by changing a resolution of an image according to an embodiment of the present invention;

FIG. 7 is a flowchart of a method of increasing storage space by changing the resolution of an image according to an embodiment of the present invention;

FIGS. 8A through 8C are views illustrating a selection of an image described in FIGS. 6 and 7; and

FIG. 9 is a view to illustrate a result of changing a resolution in FIGS. 6 and 7.

### DETAILED DESCRIPTION OF THE INVENTION

The present invention will now be described more fully with reference to the accompanying drawings, in which exemplary embodiments of the invention are shown.

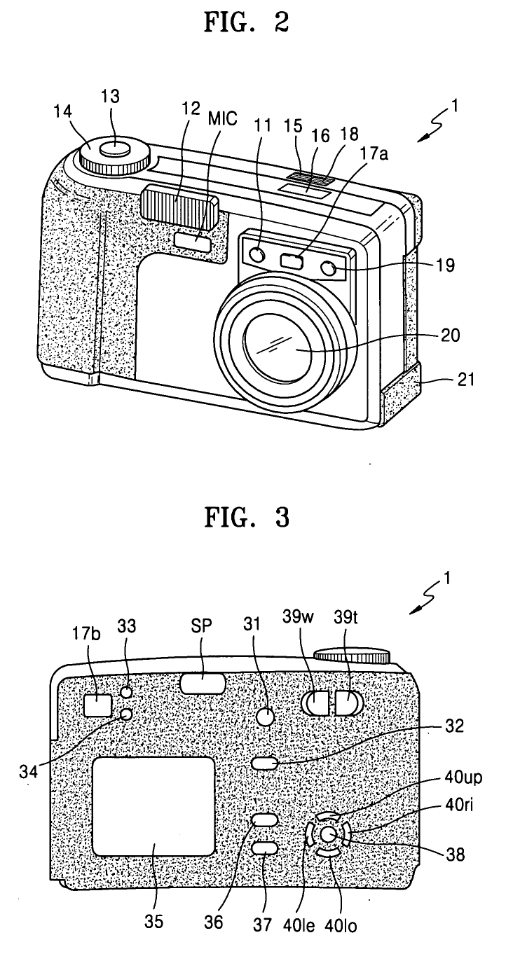

FIG. 2 is a front perspective view of a digital camera 1. Referring to FIG. 2, the digital camera 1 includes a microphone MIC, a self-timer lamp 11, a flash 12, a shutter button 13, a mode dial 14, a function-select button 15, a photograph-information display unit 16, a view finder 17a, a function-block button 18, a light sensor (LS) 19, a lens unit 20, and an external interface unit 21.

The self-timer lamp 11 operates from when the shutter button 13 is pressed to when a shutter (not shown) operates when the digital camera 1 is in a self-timer mode. The mode dial 14 is used to select various operating modes, for example, a still image photographing mode, a night scene photographing mode, a moving picture photographing mode, a reproducing mode, a computer connecting mode, and a system setting mode. The function-select button 15 is used to select one operating mode from, for example, a still image photographing mode, a night scene photographing mode, a moving picture photographing mode, and a reproducing mode of the digital camera. The photograph-information display unit 16 displays various information on each function related to photographing. The function-block button 18 is used to select one of the functions displayed on the photograph-information display unit 16.

FIG. 3 is a rear view of the digital camera 1 of FIG. 2. Referring to FIG. 3, a speaker SP, a power button 31, a monitor button 32, an automatic focus lamp 33, a view finder 17b, a flash standby lamp 34, a display panel 35, an exposure compensate/delete button 36, an enter/play button 37, a menu/OK button 38, a wide-angle zoom button 39w, a telephoto zoom button 39t, an up-movement button 40up, a right-movement button 40ri, a down-movement button 40lo, and a left-movement button 40le are included on the back of the digital camera 1.

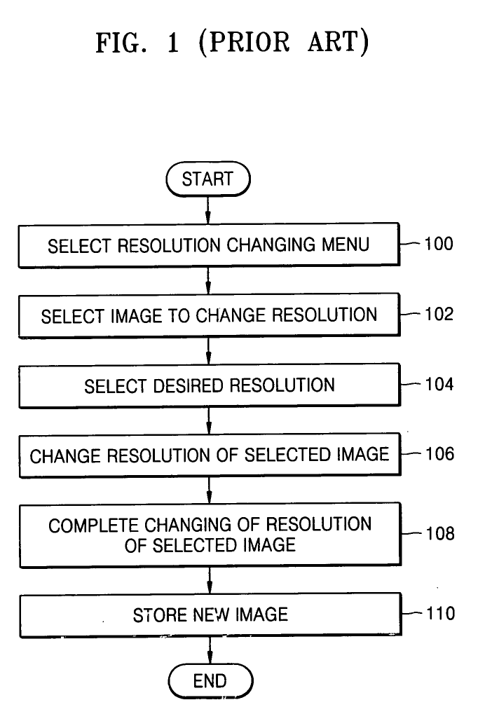

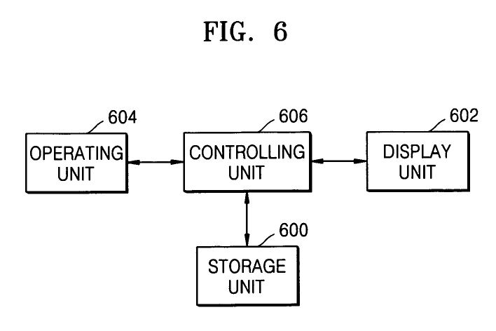

The monitor button 32 is used to control the operation of the display panel 35. When the user presses the monitor button 32 for a first time an image of a subject is displayed on the display panel 35 with photographing information. When the monitor button 32 is pressed for a second time only the image of the subject is displayed on the display panel 35 (i.e., a full screen image display mode). When the monitor button 32 is pressed for a third time the display panel 35 is turned off (e.g., to conserve power or when the user/photographer wants to only use the view finder 17b). In addition, in an embodiment of the present invention, the monitor button 32 may be used to select some of the stored images for changing their resolution. Moreover, the monitor button 32 will be described hereinafter in relation to an operating unit 604 (FIG. 6). The automatic focus lamp 33 operates when an automatic focusing operation is completed. The flash standby lamp 34 operates when the flash 12 (see FIG. 1) is in a standby state. The exposure compensate/delete button 36 controls the amount of light when the digital camera 1 is manually operated, or may be used as a delete button when a user is setting the operating mode. In addition, in an embodiment of the present invention, the exposure compensate/delete button 36 is used to continuously select stored images (i.e., select a range or series of stored images) to change the images' resolutions. Moreover, the exposure compensate/delete button 36 will be described hereinafter in relation to the operating unit 604 (FIG. 6). The enter/play button 37 is used to input data from a user or perform various functions, such as stop or play, in the reproducing mode. The menu/OK button 38 is used to display and select a menu of a mode selected by the mode dial 14. The up-movement button 40up, the right-movement button 40ri, the down-movement button 40lo, and the left-movement button 40le are also used in the process in which a user selects each of the modes.

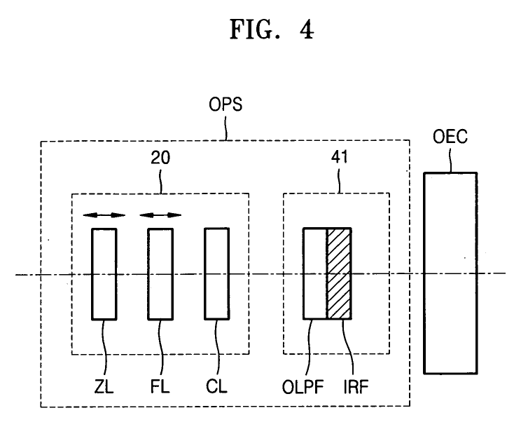

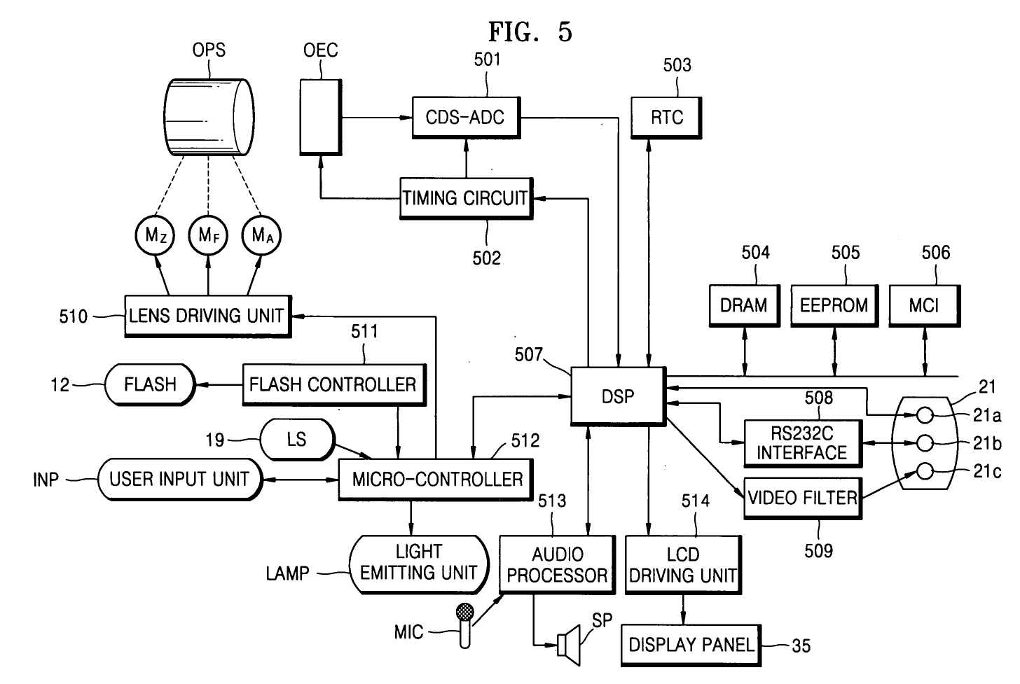

Referring now to FIGS. 4 and 5, the overall structure of the digital camera 1 will be described. As shown in FIG. 4, an optical system OPS, which includes a lens unit 20 and a filter unit 41, optically processes light reflected from a subject. The lens unit 20 of the optical system OPS includes a zoom lens ZL, a focus lens FL, and a compensation lens CL.

When a user presses the wide-angle zoom button 39w (see FIG. 2) or the telephoto zoom button 39t (see FIG. 2), a signal corresponding to the wide-angle zoom button 39w or the telephoto zoom button 39t is input to the micro-controller 512. Accordingly, as the micro-controller 512 controls a lens driving unit 510 based on the zoom signal received from buttons 39w, 39t, a zoom motor M_{Z} operates, thereby moving the zoom lens ZL. That is, if the wide-angle zoom button 39w is pressed, the focal length of the zoom lens ZL is shortened, which increases a viewing angle. Conversely, if the telephoto zoom button 39t is pressed, the focal length of the zoom lens ZL is lengthened, which decreases a viewing angle.

According to the above-mentioned characteristics, the micro-controller 512 can calculate a viewing angle θ of the location of the zoom lens ZL based on the design data (i.e., physical characteristics) of the optical system OPS. Here, the viewing angle θ is hardly affected by the location of the focus lens FL since the location of the focus lens FL can be altered while the location of the zoom lens ZL is fixed. The compensation lens CL is not separately operated since it acts to compensate the overall refractive index.

An optical low pass filter (OLPF) included in the filter unit 41 of the optical system OPS removes high frequency optical noise. An infrared cut filter (IRF) included in the filter unit 41 blocks infrared components in the incident light.

A photoelectric converter OEC of a charge coupled device (CCD) or complementary metal oxide semiconductor (CMOS) (not shown) converts light from the optical system OPS into analog electrical signals. As shown in FIG. 5, a digital signal processor (DSP) 507 controls a timing circuit 502 and controls the operation of the photoelectric converter OEC and an analog-to-digital converter ADC 501. The ADC 501 processes the analog signals from the photoelectric converter OEC and converts the analog signals into digital signals after removing high frequency noise from the analog signals and altering their bandwidth. The DSP 507 processes the digital signal from the ADC 501 and generates a digital image signal divided into a chrominance component and a luminance component.

A light emitting unit LAMP operated by the micro-controller 512 includes the self-timer lamp 11, the automatic focus lamp 33 (see FIG. 2), and the flash standby lamp 34 (see FIG. 2). A user input unit INP includes user-operable buttons and switches disposed on the camera 1, such as, the shutter button 13 (see FIG. 1), the mode dial 14 (see FIG. 1), the function-select button 15 (see FIG. 1), the function-block button 18 (see FIG. 1), the monitor button 32 (see FIG. 2), the exposure compensate/delete 36 (see FIG. 2), the enter/play button 37 (see FIG. 2), the menu/OK button 38 (see FIG. 2), the wide-angle zoom button 39w (see FIG. 2), the telephoto zoom button 39t, the up-movement button 40up (see FIG. 2), the right-movement button 40ri (see FIG. 2), the down-movement button 40lo (see FIG. 2), and the left-movement button 40le (see FIG. 2).

The digital image signal from the DSP 507 is temporarily stored in a dynamic random access memory (DRAM) 504. Algorithms needed in the operation of the DSP 507 and setting data are stored in a static memory such as electrically erasable and programmable read-only memory (EEPROM) 505. A removably insertable memory card of a user is inserted in a memory card interface (MCI) 506.

The digital image signal is output from the DSP 507 to a liquid crystal display (LCD) driving unit 514. As a result, an image is displayed on a display unit, that is, the display panel 35.

The digital image signal from the DSP 507 can be transmitted to an external device such as a television, personal computer (PC), personal digital assistant (PDA) or other electronic device known in the art. The digital image signal may be transmitted to the external device in serial form via a universal serial bus (USB) connector 21a, an RS232C interface 508 and its connector 21b, or can be transmitted as video signals via a video filter 509 and a video outputting unit 21c.

An audio processor 513 outputs an audio signal from the microphone MIC to the DSP 507 or the speaker SP, and outputs an audio signal from the DSP 507 to the speaker SP. The micro-controller 512 controls the operation of a flash controller 511 according to a signal from the LS 19 (see also FIG. 2), and thus operates the flash 12.

When the digital camera 1 is switched on, the digital camera 1 may provide a menu on the display 35. A user may select various photographing options or modes (e.g., operating modes) from the menu for the purpose of photographing an image in a predetermined or user-customized condition that the user desires.

FIG. 6 is a block diagram illustrating an embodiment of the present invention including an apparatus for increasing storage space by changing a resolution of a stored image. As shown, the embodiment includes a storage unit 600, a display unit 602, an operating unit 604, and a controlling unit 606. As one can appreciate, the apparatus of FIG. 6 may be included in the block diagram of FIG. 5, but will be described separately from FIG. 5 for convenience. Further, the units 600-606 may be related to the foregoing described structure of FIG. 5 by grouping various elements of into functional subsystems.

The storage unit 600, which may be a memory card (not shown) that is inserted into the memory card interface (MCI) 506 of FIG. 5, stores an image photographed by the digital camera 1.

The display unit 602, which may be a display panel 35, displays images stored in the storage unit 600 on a thumbnail screen. Images that are selected on the thumbnail screen for changing the images' resolutions may be displayed differently from the stored and unselected images. For example, a selected image may be marked with an indicia, highlighted or the like.

The operating unit 604 facilitates selection of at least one image displayed in the thumbnail screen provided on the display unit 602. Further, the operating unit 604 facilitates selection of a menu item for changing a resolution of the selected image. The operating unit 604 provides a selection means including a user input, herein a monitor button 32, an exposure compensate/delete button 36, and a menu/OK button 38.

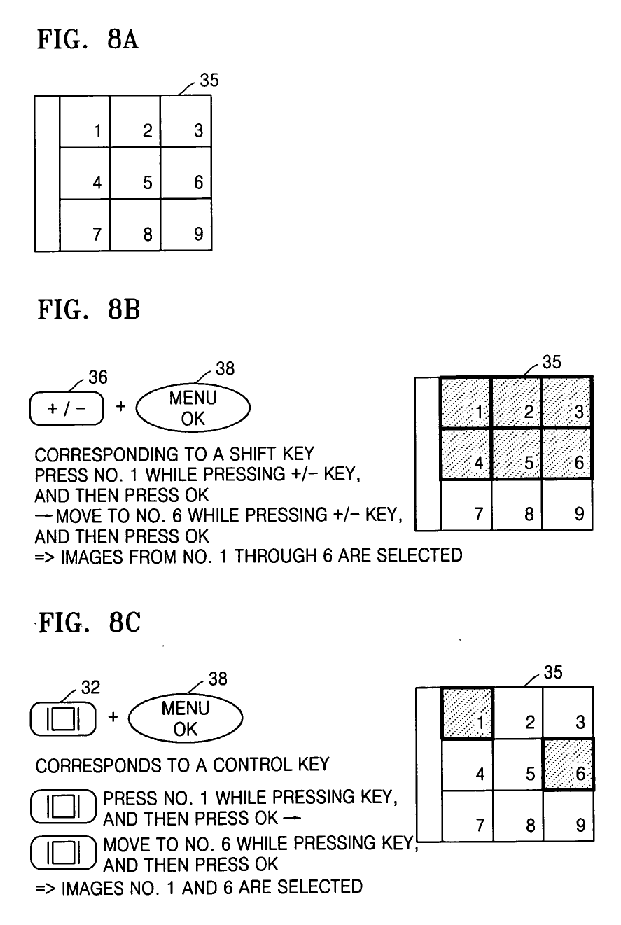

The user, via operating unit 604, may select all images stored in the storage unit 600 or a number (i.e., subset) of the images. The selecting of all the images may be performed by way of a menu item selection from a menu communicated to the display unit 602 by the controlling unit 606. A more detailed description of selecting the images will be provided hereafter with reference to FIGS. 8A-8C.

As shown in FIG. 8B, the operating unit 604 employs the exposure compensate/delete button 36 (illustrated as a plus/minus button 36) and the menu/OK button 38 to continually select a number of images. Herein, the terminology “continually select” is understood to mean, selecting a range or series of images. One should appreciate that the continually selecting operation is somewhat analogous to the process of using a computer mouse, trackball or the like to click and drag a cursor for selecting a number of adjacent objects displayed on a screen. Moreover, the continually (or continual) selecting operation may be analogized to the use of a keyboard “shift” key for choosing a number of adjacent objects (i.e., holding the shift key while pressing a directional arrow button or the like). As shown in FIG. 8A, the images stored in storage unit 600 may be displayed on the display unit 602 (e.g., display screen 35) in an array format, which is commonly known in the art as a thumbnail format. A first image in the array may be selected by pressing and holding the exposure compensate/delete button 36 while pressing the menu/OK button 38. Thereafter, the user may select a series of additional images starting with or ending with the first selected image by holding the exposure compensate/delete button 36 while pressing movement/directional buttons 40 (i.e., buttons 40up, 40lo, 40ri, and 40le) to highlight or otherwise mark images contiguous to the first selected image. When the desired series of images have been selected, the user again presses the menu/OK button 38 to confirm and end the continual selection operation. For example, the initial image that is to be selected is numbered 1 in the matrix display as illustrated in FIG. 8B. While pressing the exposure compensate/delete button 36, the right-movement button 40ri is pressed twice and the down-movement button 40lo is pressed once to mark or highlight images 1 through 6. Then, the menu/OK button 38 is pressed to end/confirm the selection.

The operating unit 604 employs the monitor button 32 and the menu/OK button 38 to selectively choose (i.e., pick and choose) a number of stored images. One should appreciate that the pick and choose image selection operation is somewhat analogous to the process of using a computer mouse, trackball or the like to “control click” a cursor for selecting a number of objects displayed on a screen. That is, in a control click operation, a user typically presses and holds the keyboard “control” key while clicking on a number of items to enjoy additional flexibility and selectivity in the items that can be selected. For example, a user may wish to select a range of items with the exception of one item therein. By pressing and holding the control button while picking (i.e., clicking on) the desired items, the undesired item may be avoided. In a further example, the user may wish to select a plurality of nonadjacent items for performing an action (e.g., copy, open, move, etc.) on each of the plurality of items simultaneously. The user may select the plurality of nonadjacent items by control clicking. Referring now to FIG. 8C, a first image in the array may be selected by pressing the monitor button 32 and the menu/OK button 38. Thereafter, the user may select additional images by continuing to press the monitor button 32 while pressing movement/directional buttons 40 (i.e., buttons 40up, 40lo, 40ri, and 40le) to highlight or mark further images. When the next image to be added to the selection is marked, the user again presses the menu/OK button 38 to add the marked image to the subset of user selected images. For example, as illustrated in FIG. 8C, the initial image that is to be selected is numbered 1 in the matrix display of screen 35. The user presses the up-movement button 40up, the right-movement button 40ri, the down-movement button 40lo, the left-movement button 40le or any combinations thereof to mark the initial image. Then, the user presses the monitor button 32 and presses and holds the menu/OK button 38 to select the initial image. Next, the user continues to hold the menu/OK button 38 and presses the right-movement button 40ri twice and the down-movement button 40lo once to mark the next image (numbered 6 in the matrix display of FIG. 8C). Finally, the next image is added to the subset of selected images by pressing the menu/OK button 38. Thus, the subset of selected images includes images 1 and 6.

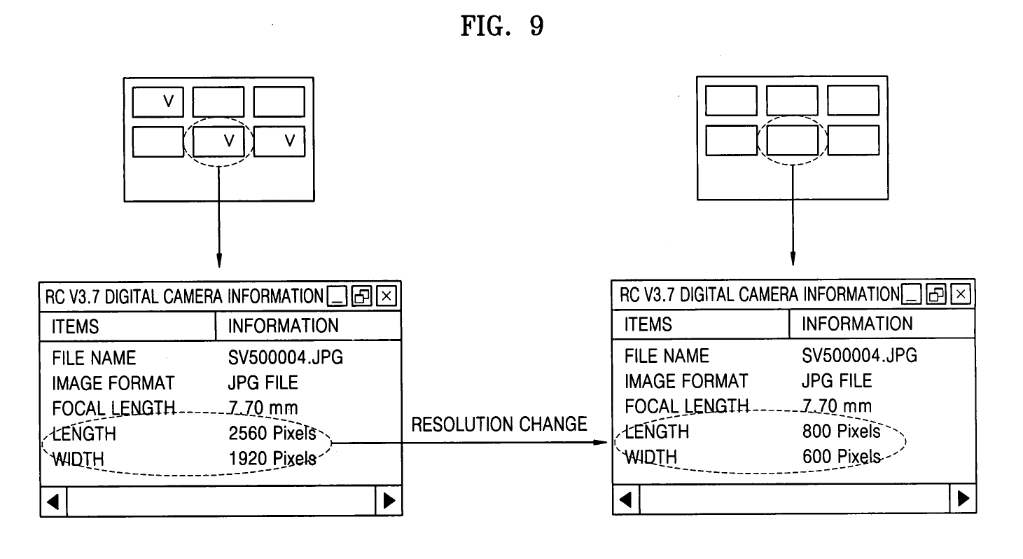

The controlling unit 606 cooperates with the display unit to provide the user with a user interface menu display for the purpose of controlling the operation of the storage unit 600, the display unit 602, and the operating unit 604. When the user desires to change the resolution of at least one stored image in the storage unit 600, the user selects the image(s) from the thumbnail screen displayed on the display unit 602 via user inputs to the operating unit 604. Detecting the user inputs from the operating unit 604, the controlling unit 606 communicates a menu display to the display unit 602. The menu display may include a number of user-selectable options for changing the resolution of the selected image(s). Once an option is selected by the user, the controlling unit 606 alters the resolution of the selected image accordingly (e.g., by discarding a number or percentage of pixels from the image). Further, the image whose resolution was changed by the controlling unit 606 may be stored over the original image (i.e., the original image may be replaced or overwritten with the new image having a changed resolution). If a resolution selected by the user is higher than the original resolution of the selected image, the controlling unit 606 may output an error message to the display unit 602, and the resolution changing operation is cancelled. The controlling unit 606 may prompt the user via a displayed menu on the display unit 602 to select a different or lower resolution. To verify or otherwise check if the resolution of an image was changed, the user may select and view an image information display screen (FIG. 9) that gives the image's attributes. The resolution of a stored image in the storage unit 600 can be checked by the controlling unit 606 through checking the exchangeable image file (Exif) information known in the art. As illustrated in FIG. 9, the Exif information displayed on an image information screen shows that an exemplary image file named SV5000004.JPG has a resolution of 800 pixels by 600 pixels after the resolution changing operation.

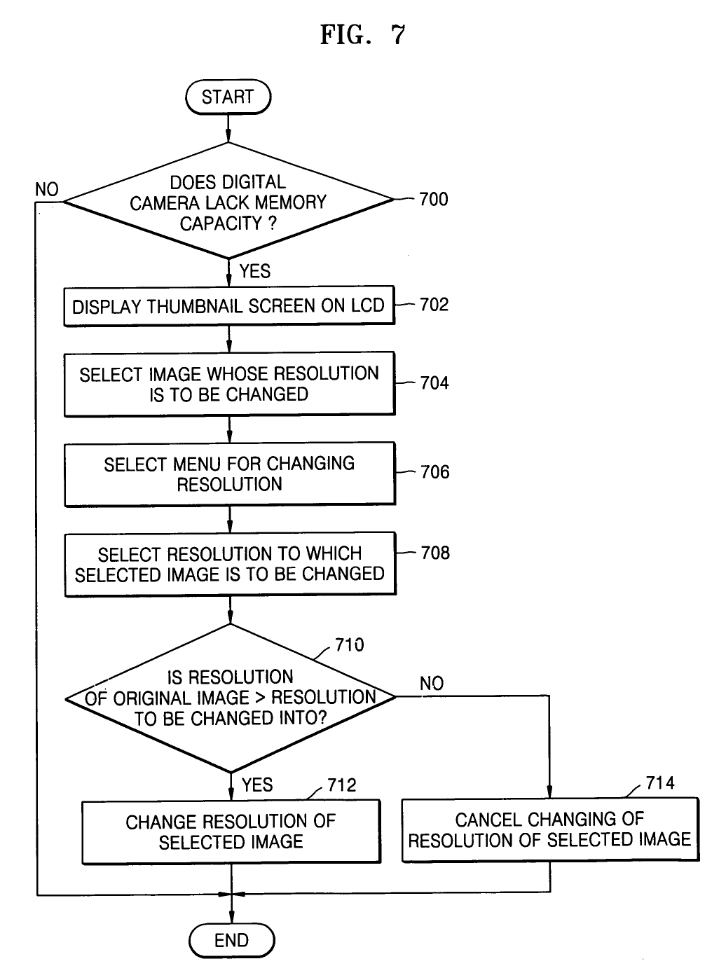

FIG. 7 is a flowchart of a method of increasing image storage space by changing a resolution of a stored image according to an embodiment of the present invention. The controlling unit 606 (e.g., DSP 507) determines whether there is a lack of storage capacity in the storage unit 600 (e.g., a memory card in MCI 506) before the user takes a picture using the digital camera 1 (Operation 700). When the storage unit 600 lacks storage capacity the controlling unit 606 outputs an alert or warning to the user. For example, the controlling unit 606 communicates with the display unit 602 to displays a message on the display (e.g., screen 35) indicating that there is a lack of storage capacity in the storage unit 600. The controlling unit 606 may provide other sensory warnings to the user such as an audio output via the speaker SP, a vibration via a vibration motor and the like known in the art.

When the storage unit 600 lacks the storage capacity to store a new image, a user may, instead of, for example, removing the full memory card and replacing it with a memory card that has sufficient storage capacity to store the new image, display a thumbnail image screen, as illustrated in FIG. 8A, on the display unit 602 menu (Operation 702).

The user selects an image from the thumbnail screen displayed on the display unit 602 for changing that image's resolution (Operation 704). The image is by the user via the operating unit 604. As previously mentioned, all images stored in the storage unit 600 may be simultaneously selected, or a number of images may be selected.

Next, the controlling unit 606 displays on the display unit 602 the select menu (e.g., a menu user interface including a number of user-selectable menu options) for changing the resolution of the selected stored image (Operation 706).

The user selects a resolution from the select menu into which the image will be changed (Operation 708). The user may select a predetermined resolution, for example, 800×600 from the provided menu. As shown in FIG. 9, the user can easily change the resolution of a selected image from 2569×1920 to 800×600. When the selection of the resolution is completed, the controlling unit 606 determines whether the resolution of the selected image is higher than the original resolution of the image (Operation 710). If the resolution to which the image is to be changed is smaller then the resolution of the original image, the resolution of the selected image is changed (Operation 712). The image with the changed resolution is then stored, for example, over-writing the original image.

However, if the resolution to which the image is to be changed is determined by the controlling unit 606 to be higher then the resolution of the original image, the controlling unit 606 cancels the changing of the resolution of the selected image (Operation 714). Further, the controlling unit 606 may output a warning or alarm alerting the user that the image's resolution was not changed.

In view of the foregoing, one can appreciate that a digital camera adopting the disclosed method helps a user to take more photographs without removing the memory unit 600 and replacing it with another memory unit 600 with sufficient image storage capacity.

While the present invention has been particularly shown and described with reference to exemplary embodiments thereof, it will be understood by those of ordinary skill in the art that various changes may be made herein without departing from the spirit and scope of the present invention as defined by the following claims.

What is claimed is:

1. A method of increasing a storage space in a digital camera apparatus, the method comprising the steps of:
displaying stored images from the storage space on a display screen of the digital camera apparatus;
selecting from the display screen at least one image having a first resolution; and
changing the at least one image to have a second resolution different from the first resolution.

2. The method of claim 1 wherein the changing step further comprises:
deleting from the storage space the selected at least one image having the first resolution; and
storing to the storage space the at least one image having the second resolution.

3. The method of claim 1 wherein the selecting step comprises selecting all images stored in the storage space.

4. The method of claim 1 wherein the selecting step comprises identifying a subset of all images stored in the storage space.

5. The method of claim 4 wherein the identifying step comprises:
marking a first image that defines a start of a range of sequential images; and
marking a second image that defines an end of the range of sequential images.

6. The method of claim 4 wherein the identifying step comprises:
marking a first image; and
marking a second image that is non-sequential relative to the first image.

7. The method of claim 1 further comprising the steps of:
determining if the second resolution is higher than the first resolution; and
providing an error message relative to the determining step if the second resolution is higher than the first resolution.

8. A method for operating a digital camera having a finite capacity image storage space, the method comprising:
photographing a first image;
storing the first image to a temporary storage space;
determining if sufficient capacity exists in the finite image storage space to store the first image thereto;
changing a resolution of at least one of the first image and a second image residing in the finite capacity image storage space; and
transferring the first image from the temporary storage space to the finite capacity image storage space.

9. The method of claim 8 wherein the changing step comprises:
displaying stored images from the finite capacity storage space on a display screen of the digital camera in a thumbnail image format;
selecting from the display screen at least one image having a first resolution; and
selecting from a menu user interface displayed on the display screen a second resolution lower than the first resolution for the at least one image.

10. The method of claim 9 wherein the selecting step comprises selecting all images stored in the storage space.

11. The method of claim 9 wherein the selecting step comprises identifying a subset of all images stored in the storage space.

12. The method of claim 11 wherein the identifying step comprises:
marking a first thumbnail image that defines a start of a range of sequential thumbnail images; and
marking a second thumbnail image that defines an end of the range of sequential thumbnail images.

13. The method of claim 11 wherein the identifying step comprises:
marking a first thumbnail image; and
marking a second thumbnail image that is non-sequential relative to the first thumbnail image.

14. A digital camera apparatus that secures a storage space in an image storage unit for a newly photographed image when capacity of the image storage unit is insufficient to store the newly photographed image, the apparatus comprising:
display means for providing a thumbnail image display of a plurality of images stored in the storage unit,
operating means for selecting at least one image having a first resolution and for selecting a lower resolution therefor, and
control means linked with the storage unit, the display means and the operating means, wherein the control means is operative to retrieve the at least one image from the image storage unit and change the at least one image to have the lower resolution in response to the operating means.

15. The digital camera apparatus of claim 14 wherein the image storage unit comprises a removably insertable memory card.

16. The digital camera apparatus of claim 14 wherein the display means comprises a driving unit in communication with a liquid crystal display panel.

17. The digital camera apparatus of claim 14 wherein the operating means includes a first button and a second button, the operating means being configured to select a range of sequential images during actuation of the first and second buttons in combination.

18. The digital camera apparatus of claim 17 wherein the operating means further includes a movement button, the operating means being configured to select a range of sequential images initialized by actuating the first and second buttons in combination, followed by holding one of the first and second buttons in an actuated state while actuating the movement button in at least one direction, and finalized by actuating the other of the first and second buttons that was not held in the actuated state.

19. The digital camera apparatus of claim 17 wherein the plurality of user-actuatable buttons further includes a third button, wherein the operating means is configured to select at least two non-sequential images during actuation of a combination of the third button and at least one of the first and second buttons.

20. The digital camera apparatus of claim 14 wherein the controlling unit comprises at least one of a digital signal processor and a micro-controller.
